(19) United States
(12) Patent Application Publication
(10) Pub. No.: US 2016/0061713 A1
(43) Pub. Date: Mar. 3, 2016

(54) METHOD OF EVALUATING OPERATIONAL FEEL OF SUBSTRATE AND SUBSTRATE

(71) Applicant: Asahi Glass Company, Limited, Chiyoda-ku (JP)

(72) Inventors: Tomonobu SENOO, Chiyoda-ku (JP); Yoshimune NONOMURA, Yonezawa-shi (JP)

(73) Assignee: Asahi Glass Company, Limited, Chiyoda-ku (JP)

(21) Appl. No.: 14/823,308

(22) Filed: Aug. 11, 2015

(30) Foreign Application Priority Data
Sep. 2, 2014 (JP) 2014-177648

(51) Int. Cl. G01N 19/02

(52) U.S. Cl. CPC G01N 19/02

(57) ABSTRACT

A method of evaluating an operational feel of a substrate includes a step of preparing a substrate having a first surface; a step of measuring a plurality of kinetic friction coefficients μ (μ₁, . . . , μ_{N}, where N is an integer greater than or equal to 2) of the first surface of the substrate, using a tactile contact, under different combinations of a friction speed and a load selected from at least one friction speed within a range from 1 mm/sec to 100 mm/sec and at least two loads within a range from 0.098 N to 1.960 N; a step of obtaining a standard deviation σ and an average value μₐᵥₑ of the plurality of kinetic friction coefficients μ that have been measured; and a step of determining at least one of whether the standard deviation σ satisfies σ<0.5 and whether the average value μₐᵥₑ satisfies μₐᵥₑ<1.4.

### BACKGROUND OF THE INVENTION

1. Field of the Invention

The present invention relates to a substrate that is applied, for example, to a protective cover of a touch panel and the like.

2. Description of the Related Art

Generally, electronic devices such as a touch panel that can be operated by a user with a finger include a protective cover made of a transparent substrate.

The protective cover is a member that is directly touched by the user, and as such, in addition to requiring optical properties such as transparency and anti-glare, the protective cover may be required to provide an operational feel upon being touched by the finger.

In this respect, Japanese Laid-Open Patent Publication No. 2010-153298 discloses a film for a touch panel that provides a tactile sensation upon being touched by the finger.

As described above, the protective cover may be required to provide an “operational feel” upon being touched by the finger. Thus, recently, substrates are being developed in consideration of technology for providing a tactile sensation upon being touched as disclosed in Japanese Laid-Open Patent Publication No. 2010-153298, for example.

However, users may have various impressions with respect to an “operational feel” of a substrate constituting a protective cover. Thus, for example, even if an “operational feel” of a substrate feels appropriate to one user, the same “operational feel” of the same substrate may not necessarily be acceptable to another user.

In turn, there is an ongoing high demand for a substrate that can provide an “operational feel” that is acceptable to a greater number of users.

### SUMMARY OF THE INVENTION

In view of the foregoing problems of the related art, an aspect of the present invention is directed to providing a substrate that is capable of providing an “operational feel” that is acceptable to a greater number of users. Another aspect of the present invention is directed to providing a method of evaluating an “operational feel” of a substrate.

According to one embodiment of the present invention, a method of evaluating an operational feel of a substrate is provided that includes (i) a step of preparing a substrate having a first surface; (ii) a step of measuring a plurality of kinetic friction coefficients μ (μ₁, . . . , μ_{N}, where N is an integer greater than or equal to 2) of the first surface of the substrate, using a tactile contact, under different combinations of a friction speed and a load selected from at least one friction speed within a range from 1 mm/sec to 100 mm/sec and at least two loads within a range from 0.098 N to 1.960 N; (iii) a step of obtaining a standard deviation σ and an average value μₐᵥₑ of the plurality of kinetic friction coefficients μ that have been measured; and (iv) a step of determining at least one of whether the standard deviation σ satisfies σ<0.5 and whether the average value μₐᵥₑ satisfies μₐᵥₑ<1.4.

According to another embodiment of the present invention, a substrate having a first surface is provided that is characterized in that when a total of fifteen kinetic friction coefficients μ₁ to μ₁₅ of the first surface of the substrate is measured, using a tactile contact, under different combinations of a friction speed and a load selected from three different friction speeds including 1 mm/sec, 10 mm/sec, and 100 mm/sec, and five different loads including 0.098 N, 0.196 N, 0.490 N, 0.980 N, and 1.960 N, a standard deviation σ of the kinetic friction coefficients μ₁ to μ₁₅ that have been measured is less than or equal to 0.5, and an average value μₐᵥₑ of the kinetic friction coefficients μ₁ to μ₁₅ that have been measured is less than or equal to 1.4.

### BRIEF DESCRIPTION OF THE DRAWINGS

FIG. 1 is a flowchart schematically illustrating a flow of a first method of evaluating an operational feel of a substrate according to an embodiment of the present invention;

FIG. 2 schematically illustrates an example of a glass substrate that may be used in a method according to an embodiment of the present invention;

FIG. 3 is a table indicating kinetic friction coefficients μ₁ to μ₁₅ in relation to measurement conditions including the friction speed and the load;

FIG. 4 is a graph schematically illustrating a relationship between a frictional force F and a time t during which a contact that receives a constant load P moves on a certain surface at a constant friction speed;

FIG. 5 schematically illustrates a substrate according to an embodiment of the present invention;

FIG. 6 is a chart indicating a relationship between the frictional force F and the time t obtained with respect to a first surface of Sample D;

FIG. 7 is a graph indicating a relationship between a standard deviation σ of the kinetic friction coefficients μ and a tactile feeling evaluation result obtained with respect to each of Samples A to F;

FIG. 8 is a graph indicating a relationship between the standard deviation σ of the kinetic friction coefficients μ and a slidability evaluation result obtained with respect to each of Samples A to F;

FIG. 9 is a graph indicating a relationship between the standard deviation σ of the kinetic friction coefficients μ and a dryness evaluation result obtained with respect to each of Samples A to F;

FIG. 10 is a graph indicating a relationship between an average value μₐᵥₑ of the kinetic friction coefficients μ and the tactile feeling evaluation result obtained with respect to each of Samples A to F;

FIG. 11 is a graph indicating a relationship between the average value μₐᵥₑ of the kinetic friction coefficients μ and the slidability evaluation result obtained with respect to each of Samples A to F; and

FIG. 12 is a graph indicating a relationship between the average value μₐᵥₑ of the kinetic friction coefficients μ and the dryness evaluation result obtained with respect to each of Samples A to F.

### DESCRIPTION OF THE PREFERRED EMBODIMENTS

In the following, embodiments of the present invention are described with reference to the accompanying drawings.

As described above, a substrate constituting a protective cover may be required to provide an “operational feel” upon being touched by the finger.

However, an “operational feel” of a substrate tends to be subjective and is felt differently depending on the user. For example, one user may feel that an operational feel of a substrate is appropriate, but another user may feel that the same operational feel of the same substrate is not satisfactory.

That is, an “operational feel” of a substrate is felt differently among various users such that it is difficult to provide a substrate that is capable of providing an “operational feel” that satisfies a large number of users.

The inventors of the present invention have dedicated their research and development efforts to solving the above problem concerning variations in the user experience with respect to an “operational feel” of a substrate. As a result of such efforts, the inventors have discovered that there are wide variations in the moving speed of the finger on a substrate, the load applied to the substrate, and moisture retention of the finger depending on each user; and that the variations in the user experience with respect to an “operational feel” of the substrate occur due to the variations in the above factors.

Further, based on the above, the inventors of the present invention have found that a substrate that is capable of providing an “operational feel” that satisfies a large number of users can be provided by correlating three representative subjective tactile sensation indicators (“tactile feeling”, “slidability”, and “dryness”) that are connected to the “operational feel” of the substrate with physical parameters including a standard deviation σ and an average value μₐᵥₑ of kinetic friction coefficients μ of the substrate surface, and in this way, the inventors have conceived the present invention.

That is, according to one embodiment of the present invention, there is provided a method of evaluating an operational feel of a substrate, the method including:

(i) a step of preparing a substrate having a first surface;

(ii) a step of measuring a plurality of kinetic friction coefficients μ(μ₁, . . . , μ_{N}; where N is an integer greater than or equal to 2) of the first surface of the substrate, using a tactile contact, under different combinations of a friction speed and a load selected from at least one friction speed within a range from 1 mm/sec to 100 mm/sec and at least two loads within a range from 0.098 N to 1.960 N;

(iii) a step of obtaining a standard deviation σ and an average value μₐᵥₑ of the plurality of kinetic friction coefficients μ that have been measured; and

(iv) a step of determining at least one of whether the standard deviation σ satisfies σ<0.5 and whether the average value μₐᵥₑ satisfies μₐᵥₑ<1.4.

According to an aspect of the present invention, the friction speed of the tactile contact during measurement of the kinetic friction coefficient μ is selected from a range from 1 mm/sec to 100 mm/sec. The friction speed in the present invention represents a relative moving speed of a substrate with respect to a tactile contact. Also, according to an aspect of the present invention, the load applied to the tactile contact during measurement of the kinetic friction coefficient μ is selected from a range from 0.098 N to 1.960 N. Note that the above ranges cover typical moving speeds of the finger and typical loads applied by the finger when a user perform touch operations on a protective cover of a touch panel or the like.

Note that of the three subjective tactile sensation indicators described above, the “tactile feeling” refers to comfort (comfortable or uncomfortable) when operating a substrate with a finger. The “slidability” refers to a sliding sensation felt upon sliding the finger on the substrate, and may represent a sensation of moving smoothly or a sensation of getting stuck, for example. Further, the “dryness” refers to a sensation of moistness felt on the substrate by the finger, and may represent a sensation of dryness, moistness, or stickiness, for example.

Based on experiments conducted by the inventors of the present invention, it has been found that these three tactile sensation indicators correlate well with the standard deviation σ of the kinetic friction coefficients μ and the average value μₐᵥₑ of the kinetic friction coefficients μ that have been measured in the manner described above. Particularly, it has been found that in a case where σ<0.5, and/or in a case where μₐᵥₑ<1.4, a substrate having desirable evaluation results with respect to the above three indicators; namely, a substrate having a desirable “operational feel” may be obtained.

Thus, according to an aspect of the present invention, user-subjective tactile sensation indicators may be organized and correlated with physical parameters including the standard deviation σ and/or the average value μₐᵥₑ of the kinetic friction coefficients μ. Further, by using these parameters as determination indicators of an “operational feel” of a substrate, a substrate with a desirable “operational feel” that would be acceptable to a greater number of users may be selected and provided.

(Method of Evaluating Operational Feel of Substrate)

In the following, a method of evaluating an operational feel of a substrate according to an embodiment of the present invention is described with reference to the accompanying drawings.

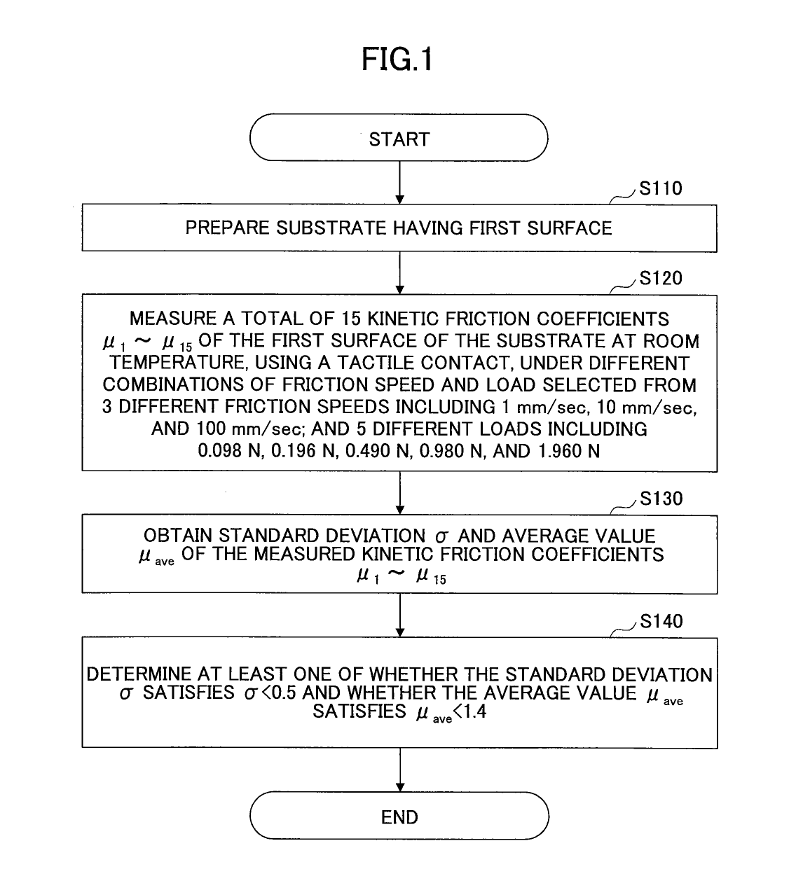

FIG. 1 is a flowchart schematically illustrating a process flow of a method of evaluating an operational feel of a substrate according to an embodiment of the present invention (hereinafter referred to as “first method”).

As illustrated in FIG. 1, the first method includes:

(i) a step of preparing a substrate having a first surface (step S110);

(ii) a step of measuring a total of 15 kinetic friction coefficients μ₁ to μ₁₅ of the first surface of the substrate, using a tactile contact, under different combinations of a friction speed and a load selected from three different friction speeds including 1 mm/sec, 10 mm/sec, and 100 mm/sec, and five different loads including 0.098 N, 0.196 N, 0.490 N, 0.980 N, and 1.960 N (step S120);

(iii) a step of obtaining a standard deviation σ and an average value μₐᵥₑ of the 15 kinetic friction coefficients μ₁ to μ₁₅ that have been measured (step S130); and

(iv) a step of determining at least one of whether the standard deviation σ satisfies σ<0.5, and whether the average value μₐᵥₑ satisfies μₐᵥₑ<1.4 (step S140).

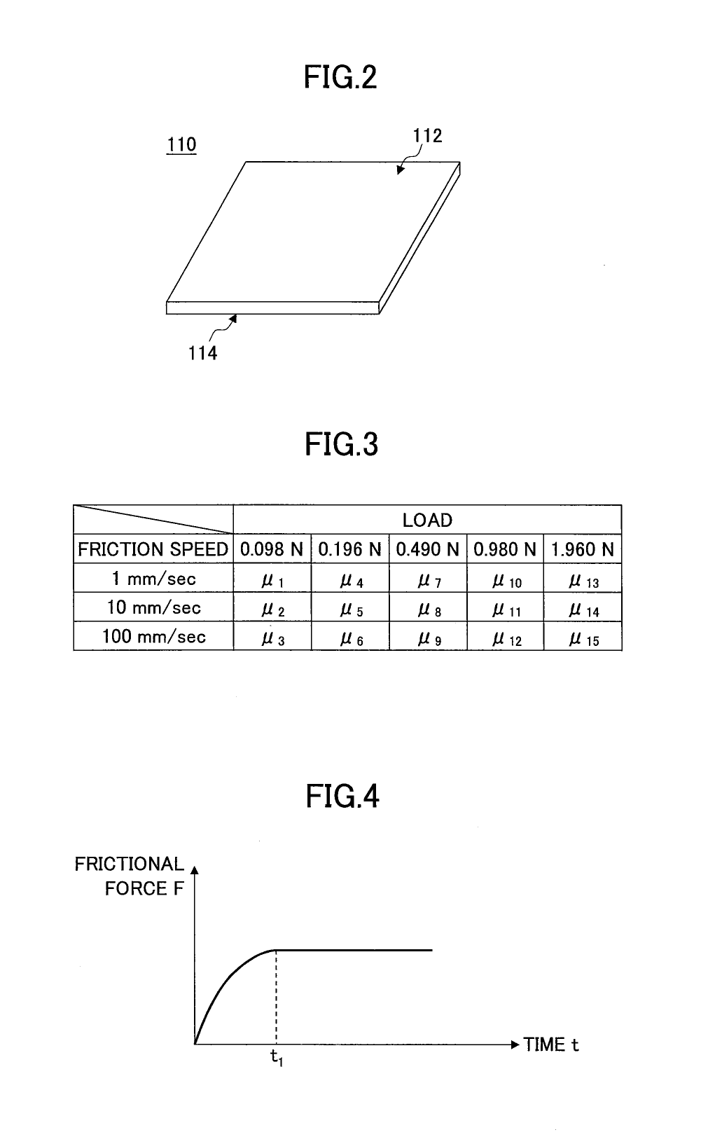

Referring also to FIGS. 2 to 4, the above steps are described in greater detail below.

Note that in the following descriptions of the process steps, an exemplary case where the substrate is made of glass is illustrated as an example. However, as is apparent to those skilled in the art, the following descriptions similarly apply, with or without partial modifications, to cases where a material other than glass such as resin or plastic is used as the substrate. Also, as is apparent to those skilled in the art, the following descriptions similarly apply, with or without partial modifications, to cases where the substrate corresponds to an opaque substrate of a touchpad mounted on a personal computer or the like, for example.

(Step S110)

First, a glass substrate is prepared.

FIG. 2 schematically illustrates an example of a glass substrate 110.

As illustrated in FIG. 2, the glass substrate 110 has a first surface 112 and a second surface 114 that opposes the first surface 112.

The composition of the glass substrate 110 is not particularly limited. For example, the glass substrate 110 may be made of soda-lime glass, aluminosilicate glass, and non-alkali glass.

The glass substrate 110 may be subject to a strengthening process, for example. In this way, the strength of the glass substrate 110 may be increased. As for the strengthening process or method used, either a chemical strengthening process (method) or a physical strengthening process (method) may be used, for example.

Note that “chemical strengthening process (method)” is a generic term for techniques that include immersing a glass substrate in molten salt containing an alkali metal, and replacing alkali metal (ions) having a small atomic diameter existing at a top surface of the glass substrate with alkali metal (ions) having a large atomic diameter existing within the molten salt. In a “chemical strengthening process (method)”, a surface of a glass substrate is processed to have alkali metal (ions) with an atomic diameter that is larger than the atomic diameter of alkali metal (ions) that were originally existing on the surface before the process. In this way, a compressive stress layer may be formed on the surface of the glass substrate, thereby improving the strength of the glass substrate.

For example, in a case where the glass substrate 110 contains sodium (Na), the sodium may be replaced by potassium (K) in the molten salt (e.g., nitrate) during the chemical strengthening process. Alternatively, for example, in a case where the glass substrate 110 contains lithium (Li), the lithium may be replaced by sodium (Na) and/or potassium (K) in the molten salt (e.g., nitrate) during the chemical strengthening process.

Note that “physical strengthening process (method)” is a generic term for techniques that include heating a glass substrate to near the softening temperature of the glass substrate, and quenching the glass substrate thereafter by blowing compressed air or the like onto the glass substrate surface to increase the compressive stress of the glass substrate surface.

Also, at least one surface of the glass substrate 110 (e.g., the first surface 112) may be subject to an anti-glare process.

In the present descriptions, the term “anti-glare process” is used to refer to a process of forming irregularities (concavo-convex structure) on the surface of the glass substrate 110 to provide the glass substrate 10 with an anti-glare function of suppressing reflection of external light.

The anti-glare process may be implemented, for example, by etching the first surface 112 of the glass substrate 110 with a processing gas containing hydrogen fluoride (HF) gas. By performing such an etching process, a large number of fine concavo-convex structures may be formed on the first surface 112.

Note that the method of implementing the anti-glare process is not limited to etching the glass substrate surface with hydrogen fluoride gas as in the example described above. In other examples, the anti-glare process may be implemented by a frosting process, an etching process, a sandblasting process, a lapping process, a silica coating process, and the like.

Also, an anti-reflection layer may be formed on at least one surface of the glass substrate 110 (e.g., the first surface 112), for example. Note that the anti-reflection layer may have any known structure, which may be a multi-layer structure or a single-layer structure. A single-layer anti-reflection layer may be formed by a material having a refractive index that is lower than the refractive index of the glass substrate 110 (approximately 1.5). For example, the single-layer anti-reflection layer may be formed by a magnesium fluoride (MgF₂) layer or a hollow silica coating layer. A multi-layer antireflection layer may be formed, for example, by alternatingly laminating about two to four layers of a high refractive material (TiO₂, Ta₂O₅, Nb₂O₅, etc.) and a low refractive material (SiO₂, MgF₂, etc.) through vapor deposition, sputtering, wet coating, or some other suitable method.

Such an anti-reflection layer as described above may be formed on the at least one surface of the glass substrate 110 (e.g., the first surface 112) that has been subject to the anti-glare process, for example.

Also, an anti-fingerprint layer (hereinafter referred to as “AFP layer”) may be formed on at least one surface of the glass substrate 110 (e.g., the first surface 112), for example. By forming the AFP layer on the first surface 112, for example, water repellency and oil repellency may be achieved at the first surface 112. In this way, the glass substrate 110 may have improved antifouling features, for example.

The AFP layer may be formed on the first surface 112 of the glass substrate 110, for example, by inducing a hydrolytic condensation reaction of a compound containing fluorine and silicon (fluorine-silicon-containing compound).

Specific examples of such a hydrolyzable fluorine-silicon-containing compound include KP-801 (product name), KY-130 (product name), KY-178 (product name), KY-185 (product name), X-71-186 (product name), and X-71-190 (product name) manufactured by Shin-Etsu Chemical Co., Ltd., and OPTOOL (registered trademark) DSX (product name) manufactured by Daikin Industries, Ltd.

Note that functional layers with anti-glare, anti-reflection and antifouling features are not limited to being formed by processing a glass substrate in the manner described above. For example, one or more of the functional layers may be formed by a coating process, or a film having at least one of the above features may be adhered to the glass substrate.

The dimensions and shape of the glass substrate 110 is not particularly limited. For example, the glass substrate 110 may have a thickness of 0.3 mm to 2.0 mm. Also, the shape of the glass substrate 110 may be substantially rectangular, substantially circular, substantially elliptical, or irregularly shaped, for example. Further, the glass substrate 110 is not limited to being flat and may have a three-dimensional shape, for example.

Note that hereinafter, the glass substrate 110 to be processed in step 120 and the subsequent steps (i.e., the glass substrate 110 that has undergone a chemical strengthening process and/or an anti-glare process, and/or has an AFP layer arranged thereon) is referred to as “glass substrate”.

(Step S120)

Then, the glass substrate prepared in step S110 is subject to measurement under various conditions. That is, kinetic friction coefficients μ of the first surface 112 are measured under various different conditions by changing the friction speed and the load applied to a contact.

More specifically, as illustrated in FIG. 3, the first surface 112 is moved relative to the contact under different combinations of the friction speed and the load respectively selected from three different friction speeds (1 mm/sec, 10 mm/sec, and 100 mm/sec) and five different loads (0.098 N, 0.196 N, 0.490 N, 0.980 N, and 1.960 N), and a total of 15 kinetic friction coefficients μ₁ to μ₁₅ are measured at room temperature (e.g., 20° C.).

Note that a tactile contact is used as the contact in order to simulate a finger.

In the following, a method of measuring the kinetic friction coefficients μ is described with reference to FIG. 4.

FIG. 4 schematically illustrates a relationship between a frictional force F and a time t during which an object that receives a certain load P moves at a certain speed on a surface (hereinafter referred to as “moving surface”).

As illustrated in FIG. 4, in general, after the object starts to move steadily (after time t=t1), a linear relationship is established between the frictional force F (kinetic frictional force Fₖ) and the time t. In this time region, the kinetic friction force Fₖ tends to take a relatively constant value irrespective of the time t.

Also, in general, the relationship between the kinetic frictional force Fₖ (N) and the load P (N) can be represented by formula (1) shown below:

Fₖ=μ×P (1)

Based on the above formula (1), by measuring the kinetic frictional force Fₖ (N) under a known load P (N) that has become constant with respect to time t, the kinetic friction coefficient μ under the corresponding condition may be calculated.

Note that in a case where the kinetic frictional force Fₖ does not take a constant value with respect to time t (e.g., in a case where the kinetic frictional force Fₖ monotonically increases along with an increase in time t), the kinetic frictional force at the time the moving distance of the object reaches 15 mm is assumed to be the kinetic frictional force Fₖ under the corresponding condition, and the kinetic friction coefficient μ is calculated based on the above formula (1).

In this way, the kinetic friction coefficients μ₁ to μ₁₅ of the first surface 112 of the glass substrate under various different conditions may be obtained.

(Step S130)

Then, the standard deviation σ and the average value μₐᵥₑ of the 15 kinetic friction coefficients μ₁ to μ₁₅ obtained in step S120 are calculated.

The standard deviation σ is determined based on formula (2) shown below:

$${σ}^{2} = \frac{1}{N} {\sum }_{i = 1}^{N} {( {μ}_{i} - {μ}_{ave} )}^{2} \qquad ( 2 )$$

In the above formula (2), N represents the number of data items (N=15 in the present first method), and μₐᵥₑ represents the average value of the kinetic friction coefficients μ (the 15 kinetic friction coefficients μ₁ to μ₁₅ in the present first method).

(Step S140)

Then, at least one of the following determinations is made. That is, using the standard deviation σ obtained in step S130, a determination may be made as to whether the standard deviation σ satisfies formula (3) shown below:

σ<0.5 (3)

Also, using the average value μₐᵥₑ obtained in step S130, a determination may be made as to whether the average value μₐᵥₑ satisfies formula (4) shown below:

μₐᵥₑ<1.4 (4)

As described in detail below, experimental results obtained by the present inventors revealed that the three subjective tactile sensation indicators including the “tactile feeling”, the “slidability”, and the “dryness” correlate well with the standard deviation σ of the kinetic friction coefficients μ₁ to μ₁₅ and the average μₐᵥₑ of the kinetic friction coefficients μ₁ to μ₁₅.

That is, the experimental results revealed that when a glass substrate has the first surface 112 that satisfies the formula (3) or the formula (4), satisfactory user evaluation results can also be obtained with respect to each of the tactile sensation indicators including the “tactile feeling”, the “slidability”, and the “dryness”.

Thus, by determining whether the standard deviation a satisfies the formula (3), or whether the average value μₐᵥₑ satisfies the formula (4), the “operational feel” of the glass substrate may be evaluated. In other words, by selecting a glass substrate having the first surface 112 that satisfies the formula (3) and the formula (4), a glass substrate having an “operational feel” that is acceptable to a greater number of users may be provided.

A method of evaluating an “operational feel” of a substrate according to one embodiment of the present invention has been described above with reference to FIG. 1. However, as is apparent to those skilled in the art, a method of evaluating an “operational feel” of a substrate according to the present invention is not limited to the above-described embodiment.

For example, according to one aspect of the present invention, in step S120, any value within the range from 1 mm/sec to 100 mm/sec may be freely selected as the friction speed of the tactile contact, and the number of friction speeds to be used as measurement conditions may be any number greater than or equal to one. Similarly, in step S120, any value within the range from 0.098 N to 1.960 N may be freely selected as the load applied to the tactile contact, and the number of loads to be used as measurement conditions may be any number greater than or equal to two.

According to another aspect of the present invention, in step S120, any value within the range from 1 mm/sec to 100 mm/sec may be freely selected as the friction speed of the tactile contact, and the number of friction speeds to be used as measurement conditions may be any number greater than or equal to two. Similarly, in step S120, any value within the range from 0.098 N to 1.960 N may be freely selected as the load applied to the tactile contact, and the number of loads to be used as measurement conditions may be any number greater than equal to one.

That is, the number of kinetic friction coefficients μ that are measured in step S120 is not particularly limited as long as at least two kinetic friction coefficients μ are measured. For example, 2, 3, 4, 5, 6, 8, 9, 10, 12, or 16 kinetic friction coefficients μ may be measured.

Note that as the number of kinetic friction coefficients μ that are measured increases, the accuracy of the standard deviation σ and the average value μₐᵥₑ may be improved. In this respect, the number of kinetic friction coefficients μ to be measured is preferably greater than or equal to 6, and more preferably greater than or equal to 15.

Also, in the above first method, in step S140, either the formula (3) or the formula (4) may be used as a determination indicator of the “operational feel” of the substrate. Alternatively, both the formula (3) and the formula (4) may be used as determination indicators.

(Substrate)

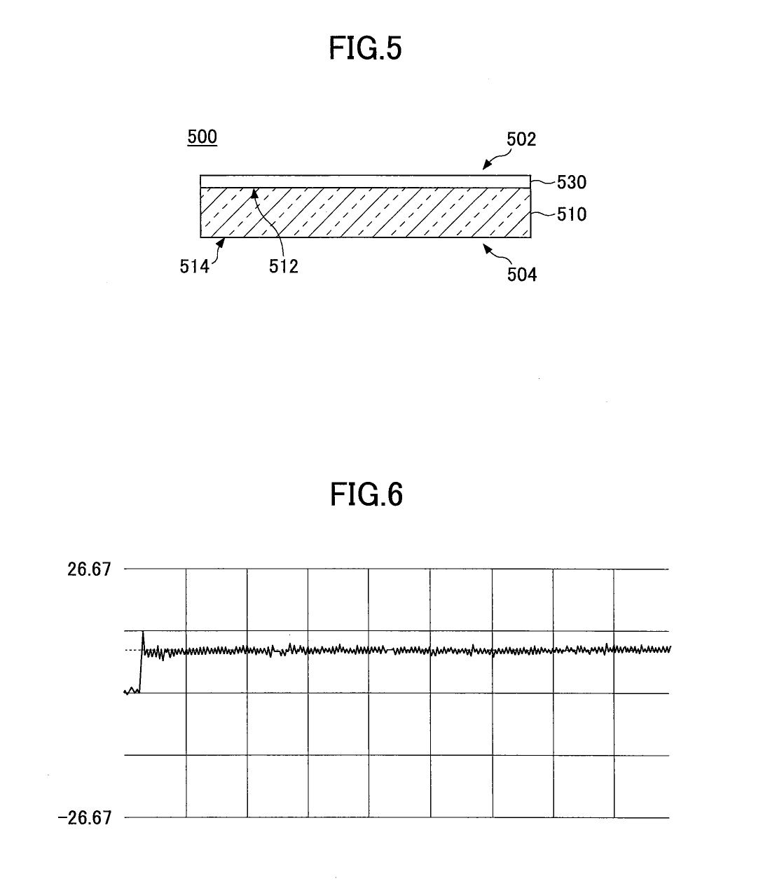

In the following, a substrate according to an embodiment of the present invention is described with reference to FIG. 5.

FIG. 5 schematically illustrates a substrate 500 according to an embodiment of the present invention.

As illustrated in FIG. 5, the substrate 500 includes a first surface 502 and a second surface 504. Also, the substrate 500 includes a transparent substrate 510 having a first surface 512 and a second surface 514. Further, the first surface 512 of the transparent substrate 510 corresponds to a surface that has undergone an anti-glare process.

Also, in the example illustrated in FIG. 5, the substrate 500 has an AFP layer 530 arranged on the first surface 512 of the transparent substrate 510. Note, however, that the AFP layer 530 is a member that is optionally provided, and the substrate 500 does not necessarily have to include the AFP layer 530.

The substrate 500 is characterized in that when a total of 15 kinetic friction coefficients μ₁ to μ₁₅ of the first surface 502 are measured, using a tactile contact, under different combinations of a friction speed and a load respectively selected from three different friction speeds including 1 mm/sec, 10 mm/sec, and 100 mm/sec, and five different loads including 0.098 N, 0. 196 N, 0.490 N, 0.980 N, and 1.960 N, the standard deviation σ of the measured kinetic friction coefficients μ₁ to μ₁₅ satisfies:

σ<0.5 (3)

and the average value μₐᵥₑ of the kinetic friction coefficients μ₁ to μ₁₅ satisfies:

μₐᵥₑ<1.4 (4).

As described above, the standard deviation σ and the average value μₐᵥₑ of the kinetic friction coefficients μ₁ to μ₁₅ correlate well with the three subjective tactile sensation indicators including the “tactile feeling”, the “slidability”, and the “dryness”. As such, when the standard deviation σ satisfies the formula (3), or the average value μₐᵥₑ satisfies the formula (4), satisfactory evaluation results for the three tactile indicators may be obtained from a relatively large number of users.

Thus, when the substrate 500 has the first surface 502 that satisfies the formula (3) and the formula (4), the substrate 500 may be able to provide an “operational feel” that is acceptable to a relatively large number of users.

(Details of Substrate 500)

In the following, the members constituting the substrate 500 illustrated in FIG. 5 are described in greater detail. Note that in the following, a case where the substrate 500 is a flat transparent substrate is described as an illustrative example. However, the substrate 500 may also be a non-transparent substrate, for example.

(Transparent Substrate 510)

The material of the transparent substrate 510 is not particularly limited as long as the material is transparent. For example, the transparent substrate 510 may be made of glass, resin, or plastic.

When the transparent substrate 510 is made of glass, the composition of the glass is not particularly limited. For example, the glass may be made of soda-lime glass or aluminosilicate glass. Further, when the transparent substrate 510 is made of glass, the transparent substrate 510 may be subject to a chemical strengthening process.

Also, the first surface 512 of the transparent substrate 510 may be subject to an anti-glare process. The method of implementing the anti-glare process is not particularly limited, and for example, a frosting process, an etching process, a sandblasting process, a lapping process, or a silica coating process may be used.

Also, the arithmetical mean deviation of the roughness profile (Ra) of the first surface 512 of the transparent substrate 510 may be, for example, within a range from 10 nm to 700 nm, more preferably within a range from 30 nm to 500 nm, and more preferably within a range from 50 nm to 300 nm. Also, the mean width of the roughness profile elements (RSm) of the first surface 512 of the transparent plate 510 may be, for example, within a range from 10 μm to 300 μm, more preferably within a range from 15 μm to 300 μm, and more preferably within a range from 20 μm to 300 μm.

(AFP Layer 530)

The AFP layer 530 may be arranged on the first surface 512 of the transparent substrate 510 as necessary, for example.

By including the AFP layer 530, the first surface 502 of the substrate 500 may have water repellency and oil repellency features, for example. Also, in this way, the substrate 500 may have improved antifouling features, for example.

The type of the AFP layer 530 is not particularly limited. For example, the AFP layer 530 may be made of a compound containing fluorine and silicon (silicon-fluorine-containing compound).

Such an AFP layer 530 made of a fluorine-silicon-containing compound may be formed on the first surface 512 of the transparent substrate 510, for example, by inducing a hydrolytic condensation reaction of a hydrolyzable fluorine-silicon-containing compound.

Specific examples of such a hydrolyzable fluorine-silicon-containing compound include KP-801 (product name), KY-130 (product name), KY-178 (product name), KY-185 (product name), X-71-186 (product name), and X-71-190 (product name) manufactured by Shin-Etsu Chemical Co., Ltd., and OPTOOL (registered trademark) DSX (product name) manufactured by Daikin Industries, Ltd.

The thickness of the AFP layer 530 is not particularly limited. For example, the thickness of the AFP layer 530 may range from a monomolecular layer thickness to 30 nm. Further, the thickness of the AFP layer 530 may be, for example, greater than or equal to 1 nm, and more preferably greater than or equal to 3 nm. More preferably, the thickness of the AFP layer 530 may be within a range from 5 nm to 20 nm, for example.

(Substrate 500)

The dimensions and the shape of the substrate 500 is not particularly limited. For example, the substrate 500 may have a square shape, a rectangular shape, a circular shape, an elliptical shape, or an irregular shape. Further, the substrate 500 is not limited to being flat and may have a three-dimensional shape.

Note that in the case of using the substrate 500 as a protective cover of a touch panel, the thickness of the substrate 500 is preferably relatively thin. For example, the thickness of the substrate 500 may be within a range from 0.2 mm to 3.0 mm, more preferably less than or equal to 2.0 mm, and more preferably less than or equal to 1.0 mm.

### APPLICATION EXAMPLES

In the following, application examples of the present invention are described.

(Evaluation of Operational Feel of Substrate)

As described below, six types of glass substrates with first surfaces in various different states were prepared, and the operational feel of the first surface of each of the glass substrates was evaluated.

(Glass Substrate Manufacturing)

First, six glass substrates having first surfaces in various different states (hereinafter referred to as Sample A to Sample F) were manufactured.

Sample A was manufactured in the following manner. First, a glass substrate having vertical-horizontal-thickness dimensions of 100 mm×80 mm×1 mm (Dragontrail (registered trademark) manufactured by Asahi Glass Co., Ltd.) was prepared.

Next, an etching process using hydrogen fluoride gas was performed on the first surface of the glass substrate (one surface of the glass substrate having dimensions of 100 mm×80 mm) to form a fine concavo-convex structure on the first surface. The etching condition used in the above etching process is hereinafter referred to as “HF process condition 1”. In this way, an anti-glare process was performed on the first surface.

Then, a chemical strengthening process was performed on the glass substrate.

Then, an AFP layer (KY-178 manufactured by Shin-Etsu Chemical Co., Ltd.) was formed on the first surface of the glass substrate. In this way, Sample A having an AFP layer formed on the first surface was obtained.

Sample B to Sample E were manufactured in a manner similar to that described above.

However, in Sample B, an etching condition that differs from the etching condition used for manufacturing Sample A was used to etch the first surface (hereinafter referred to as “HF process condition 2”). In Sample C, an etching condition that differs from the etching conditions used for manufacturing Sample A and Sample B was used to etch the first surface (hereinafter referred to as “HF process condition 3”), and an AFP layer was not formed on the first surface. In Sample D, an etching condition that differs from the etching conditions for manufacturing Sample A to Sample C was used to etch the first surface (hereinafter referred to as “HF process condition 4”), and an AFP layer was not formed on the first surface. In Sample E, an etching process was not performed on the first surface and only an AFP layer was formed on the first surface. Further, for comparison, a glass substrate (Dragontrail (registered trademark) manufactured by Asahi Glass Co., Ltd.) on which neither an etching process nor an AFP layer formation process was performed was prepared as Sample F.

With respect to Sample A to Sample D manufactured in the above-described manner, the surface roughness (Ra and RSm) of the first surface of each of the samples was measured using a laser microscope (VK-9700 manufactured by Keyence Corporation). Note that Ra represents the arithmetical mean deviation of the roughness profile (arithmetic mean roughness), and RSm represents the mean width of the roughness profile elements (mean width of the profile curve elements in a sampling length).

Table 1 below shows the surface roughness measurement results and the manufacturing conditions of each of the above samples.

TABLE 1

| | | | SURFACE | |
|---|---|---|---|---|
| | | | ROUGHNESS | |
| | HF PROCESS | | Ra | RSm |
| SAMPLE | CONDITION | AFP LAYER | (nm) | (μm) |
| A | 1 | YES | 99 | 221.8 |
| B | 2 | YES | 124 | 70.4 |
| C | 3 | NO | 109 | 24.7 |
| D | 4 | NO | 259 | 55.1 |
| E | — | YES | — | — |
| F | — | NO | — | — |

(Survey Evaluations)

Then, 29 people selected at random were asked to perform touch operations on the first surface of each of Sample A to Sample F using their fingers to evaluate the samples, and evaluation scores obtained from the survey were aggregated. The participants of the survey consisted of 21 adult males and 8 adult females.

Note that the survey was carried out in the following manner:

(1) Each survey participant performs touch operations on the first surface of each of Sample A to Sample F, imaging that he/she is operating a smartphone.

(2) Each survey participant evaluates the result of the touch operation experience by scoring the “tactile feeling”, the “slidability”, and the “dryness” of each sample on a 7-point scale.

Note that in the above evaluation, as a rough guide, 0 points to 3 points may be given in a case where the corresponding property is “unacceptable”, 4 points to 7 points may be given in a case where the corresponding property is “acceptable”, and around 3 points to 4 points may be given in a case where the corresponding property is “neither” acceptable nor unacceptable. Also, zero points may be given in a case where the corresponding property is “absolutely unacceptable”, and 7 points may be given in a case where the corresponding property is “extremely favorable”.

(3) An average of the scores obtained for each of the above three properties obtained with respect to each of Sample A to Sample F was calculated, and the average scores were used as evaluation scores.

Table 2 below shows the evaluation scores (average) obtained with respect to each of Sample A to Sample F.

TABLE 2

| | EVALUATION SCORE (AVERAGE) | | |
|---|---|---|---|
| | TACTILE | | |
| SAMPLE | FEELING | SLIDABILITY | DRYNESS |
| A | 3.83 | 3.79 | 3.45 |
| B | 5.03 | 5.41 | 5.10 |
| C | 3.79 | 3.83 | 3.79 |
| D | 4.62 | 4.97 | 5.24 |
| E | 3.59 | 3.69 | 3.17 |
| F | 2.79 | 2.83 | 3.14 |

(Friction Behavior Evaluation)

Next, with respect to each of Sample A to Sample F, kinetic friction coefficients of the first surface were evaluated. The evaluation was conducted using a kinetic friction meter (manufactured by Trinity Lab Inc.) and an accompanying tactile contact of the friction meter as a contact.

Specifically, one of Sample A to Sample F was mounted on a movable stage of the kinetic friction meter, the moving speed of the movable stage (i.e., the friction speed) and the load on the contact were each selected to satisfy one of the measurement conditions described below, and the kinetic friction coefficient μ of the first surface 112 under the corresponding measurement condition was measured. The moving distance of the movable stage, namely, the friction distance was arranged to be 30 mm.

The measurement conditions include a total of 15 different combinations of the friction speed and the load, respectively selected from three different friction speeds (100 mm/sec, 10 mm/sec, and 1 mm/sec) and five different loads (0.098 N, 0.196 N, 0.490 N, 0.980 N, and 1.960 N). Under each of the above measurement conditions, the kinetic friction measurement was repeatedly conducted three times, and the average value of the measurement results was used as the kinetic friction coefficient μᵢ (i=1 to 15) under the corresponding measurement condition. Further, the measurement was conducted under an environment of 23° C., 40% RH (relative humidity).

With respect to each of Sample A to Sample F, a relationship between the time t and the frictional force F under each of the above measurement conditions was obtained. Further, based on the obtained relationship, the kinetic friction coefficient μ was calculated using the above formula (1).

In this way, 15 kinetic friction coefficients μ₁ to μ₁₅ corresponding to the different measurement conditions (see FIG. 3) were obtained with respect to each of Sample A to Sample F.

FIG. 6 illustrates a relationship between the time t and the frictional force F obtained with respect to the first surface of Sample D as an example. Note that the illustrated measurement corresponds to that obtained under a friction speed of 1 mm/sec and a load of 0.98 N.

Although omitted for the sake of simplifying the descriptions, similar behaviors with different values for the kinetic frictional force Fₖ can be observed in the relationship between the time t and the kinetic frictional force Fₖ for Sample D under the other measurement conditions as well as the relationship between the time t and the kinetic frictional force Fₖ for the other samples including Samples A, B, C, E, and F.

As can be appreciated from FIG. 6, the frictional force F after the movable stage starts moving (i.e., kinetic frictional force Fₖ) is substantially constant with respect to time t. However, the frictional force F may repeatedly undergo small increases and decreases (amplitude). In the present example, a center value of the amplitude of the frictional force F (see broken line in FIG. 6) was used as the kinetic frictional force Fₖ when such variations in the frictional force F were observed.

Table 3 shows the kinetic friction coefficients μ₁ to μ₁₅ for each of Sample A to Sample F obtained under each of the measurement conditions. Also, Table 3 shows the standard deviation σ of the kinetic friction coefficients μ₁ to μ₁₅ and the average value μₐᵥₑ of the kinetic friction coefficients μ₁ to μ₁₅ for each of Sample A to Sample F.

TABLE 3

| MEASUREMENT | | | | | | | |
|---|---|---|---|---|---|---|---|
| CONDITION | | | | | | | |
| MOVING | | SAMPLE | | | | | |
| SPEED | LOAD | A | B | C | D | E | F |
| 100 mm/sec | 0.098 N | 0.41 | 0.18 | 1.04 | 0.47 | 1.01 | 2.10 |
| 100 mm/sec | 0.196 N | 0.42 | 0.17 | 1.02 | 0.46 | 1.27 | 2.59 |
| 100 mm/sec | 0.490 N | 0.44 | 0.22 | 1.00 | 0.47 | 1.44 | 3.15 |
| 100 mm/sec | 0.980 N | 0.48 | 0.21 | 1.08 | 0.44 | 1.20 | 3.35 |
| 100 mm/sec | 1.960 N | 0.53 | 0.20 | 1.29 | 0.44 | 1.15 | 3.16 |
| 10 mm/sec | 0.098 N | 0.22 | 0.19 | 1.28 | 0.62 | 0.38 | 0.95 |
| 10 mm/sec | 0.196 N | 0.23 | 0.22 | 1.34 | 0.69 | 0.49 | 1.31 |
| 10 mm/sec | 0.490 N | 0.25 | 0.21 | 1.19 | 0.74 | 0.60 | 1.74 |
| 10 mm/sec | 0.980 N | 0.30 | 0.21 | 1.19 | 0.65 | 1.08 | 2.42 |
| 10 mm/sec | 1.960 N | 0.35 | 0.16 | 1.38 | 0.75 | 1.83 | 3.51 |
| 1 mm/sec | 0.098 N | 0.14 | 0.17 | 1.32 | 0.70 | 0.16 | 0.91 |
| 1 mm/sec | 0.196 N | 0.15 | 0.13 | 0.84 | 0.78 | 0.23 | 1.13 |
| 1 mm/sec | 0.490 N | 0.19 | 0.19 | 0.84 | 0.70 | 0.34 | 1.41 |
| 1 mm/sec | 0.980 N | 0.30 | 0.18 | 0.84 | 0.88 | 0.66 | 2.07 |
| 1 mm/sec | 1.960 N | 0.38 | 0.33 | 0.92 | 0.81 | 1.24 | 2.55 |

| | | | | | | |
|---|---|---|---|---|---|---|
| KINETIC FRICTION | 0.32 | 0.20 | 1.10 | 0.64 | 0.87 | 2.16 |
| COEFFICIENT | | | | | | |
| AVERAGE VALUE | | | | | | |
| μₐᵥₑ | | | | | | |
| KINETIC FRICTION | 0.12 | 0.04 | 0.19 | 0.15 | 0.50 | 0.89 |
| COEFFICIENT | | | | | | |
| STANDARD | | | | | | |
| DEVIATION σ | | | | | | |

(Standard Deviation σ and Average Value μₐᵥₑ of Kinetic Friction Coefficients μ₁ to μ₁₅)

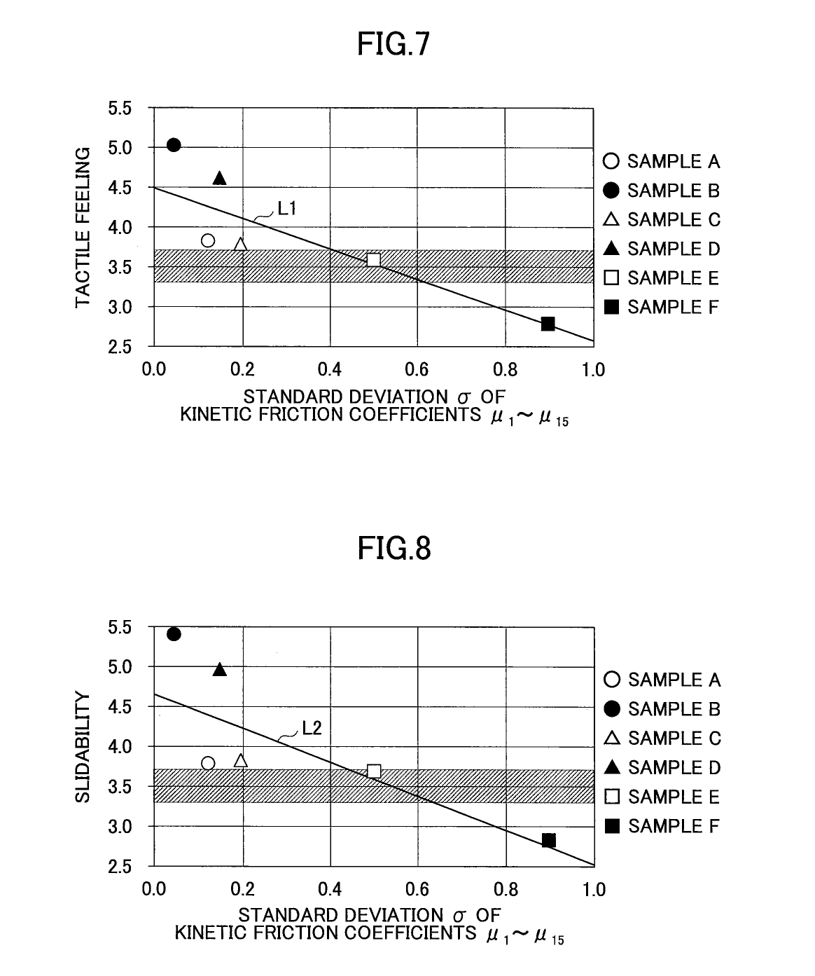

FIG. 7 is a graph illustrating a relationship between the evaluation results for the tactile feeling and the standard deviation σ of the kinetic friction coefficients μ₁ to μ₁₅ (hereinafter, simply referred to as “standard deviation σ”) obtained with respect to each of Sample A to Sample F. Note that in FIG. 7, the horizontal axis represents the standard deviation σ, and the vertical axis represents the evaluation score for the tactile feeling.

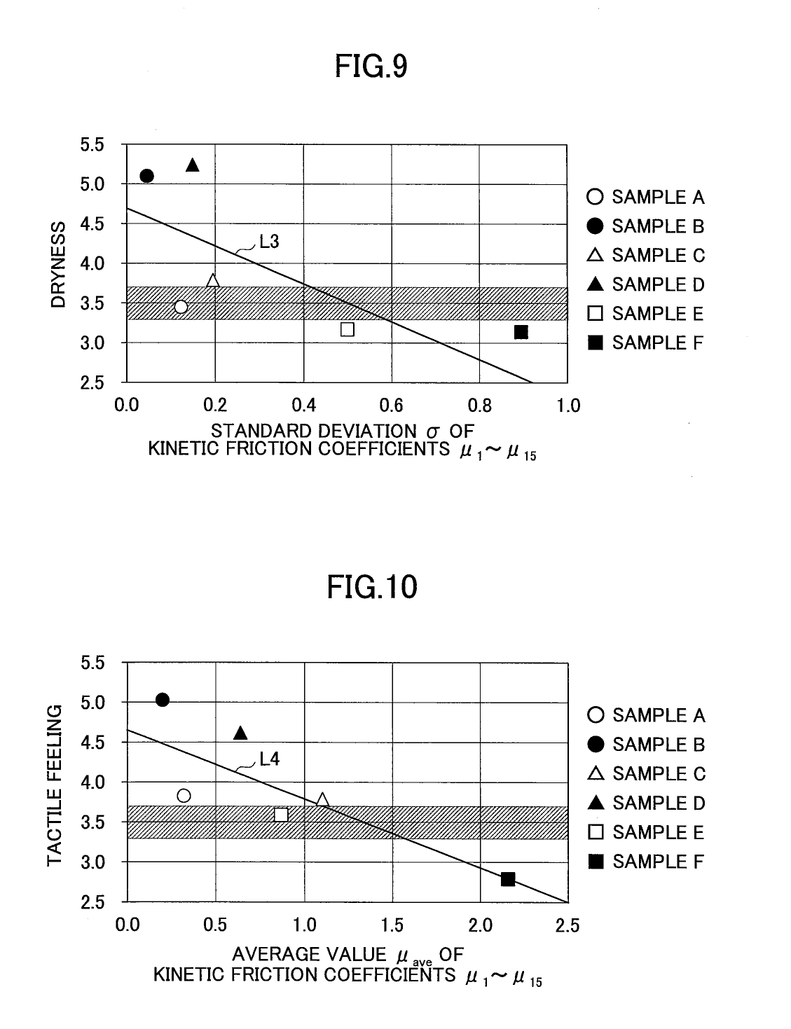

FIG. 8 is a graph illustrating a relationship between the evaluation results for the slidability and the standard deviation σ obtained with respect to each of Sample A to Sample F. FIG. 9 is a graph illustrating a relationship between the evaluation results for the dryness and the standard deviation σ obtained with respect to each of Sample A to Sample F. In FIG. 8, the horizontal axis represents the standard deviation σ, and the vertical axis represents the evaluation score for the slidability. In FIG. 9, the horizontal axis represents the standard deviation σ, and the vertical axis represents the evaluation score for the dryness.

As can be appreciated from FIGS. 7 to 9, the standard deviation σ obtained with respect to each of the samples correlate well with the three tactile sensation indicators including the tactile feeling, the slidability, and the dryness. That is, as the standard deviation σ decreases, a surface with a better tactile feeling, improved slidability, and adequate dryness can be obtained.

Note that in FIGS. 7 to 9, straight lines (L1 to L3) respectively approximating the correlations between the standard deviation o and the evaluation scores for the three tactile sensation indicators are indicated for the purpose of reference.

In the following, it is assumed that a range from 3.3 points to 3.7 points, corresponding to a range including the middle point of the full score (7 points) and points within close range of the middle point, is used as a threshold for determining whether the tactile feeling of each of Sample A to Sample F is acceptable. In this case, based on the straight line L1 of FIG. 7 representing the correlation between the evaluation score for the tactile feeling and the standard deviation σ, an acceptable score for the tactile feeling may be obtained when the standard deviation σ is approximately within a range of σ<0.5.

Similarly, the range from 3.3 points to 3.7 points is assumed to be a threshold for determining whether the slidability of each of Sample A to Sample F is acceptable. In this case, based on the straight line L2 of FIG. 8 representing the correlation between the evaluation score for the slidability and the standard deviation σ, an acceptable score for the slidability may be obtained when the standard deviation σ is approximately within the range of σ<0.5.

Further, as with the thresholds for the tactile feeling and the slidability, the range from 3.3 points to 3.7 points is assumed to be a threshold for determining whether the dryness of each of Sample A to Sample F is acceptable. In this case, based on the straight line L3 of FIG. 9 representing the correlation between the evaluation score for the dryness and the standard deviation σ, an acceptable score for the dryness may be obtained when the standard deviation σ is approximately within the range of σ<0.5.

Based on the above, it can be appreciated that when the standard deviation σ satisfies the condition σ<0.5, scores exceeding the acceptability thresholds for the tactile sensation indicators including the tactile feeling, the slidability, and the dryness may be obtained. Thus, by selecting a substrate having a first surface that satisfies the condition σ<0.5, a substrate having an “operational feel” that is acceptable to many users may be obtained.

Note that with respect to the above determination indicator (σ<0.5), of the six different samples including Sample A to Sample F used in the above experiments, in terms of the tactile feeling, Sample F is not acceptable, and Sample E is at the borderline. Also, in terms of the slidability, Sample F is not acceptable, and Sample E is at the borderline. In terms of the dryness, Sample F and Sample E are not acceptable.

FIG. 10 is a graph illustrating a relationship between evaluation results for the tactile feeling and the average value μₐᵥₑ of the kinetic friction coefficients μ₁ to μ₁₅ (hereinafter simply referred to as “average μₐᵥₑ”) obtained with respect to each of Sample A to Sample F. In FIG. 10, the horizontal axis represents the average value μₐᵥₑ, and the vertical axis represents the evaluation score for the tactile feeling.

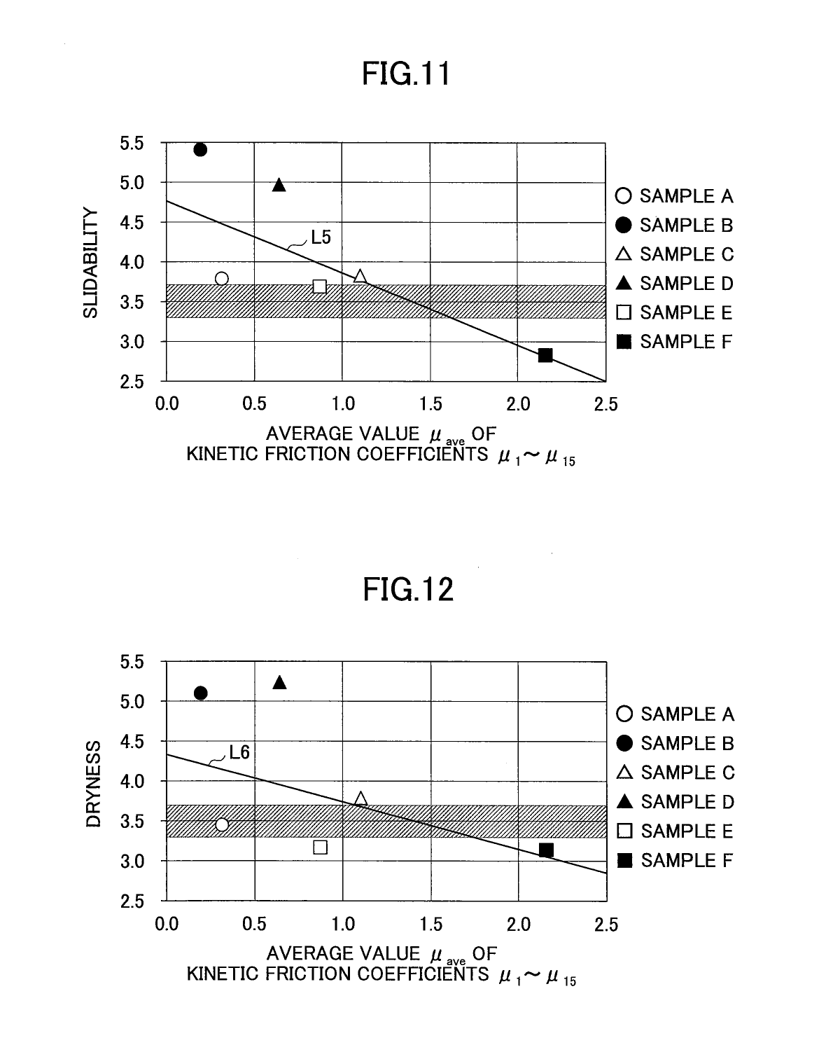

FIG. 11 is a graph illustrating a relationship between evaluation results for the slidability and the average value μₐᵥₑ obtained with respect to each of Sample A to Sample F. FIG. 12 is a graph illustrating a relationship between evaluation results for the dryness and the average value μₐᵥₑ obtained with respect to each of Sample A to Sample F. In FIG. 11, the horizontal axis represents the average value μₐᵥₑ, and the vertical axis represents the evaluation score for the slidability. In FIG. 12, the horizontal axis represents the average value μₐᵥₑ, and the vertical axis represents the evaluation score for the dryness.

As can be appreciated from FIGS. 10 to 12, the average value μₐᵥₑ obtained with respect to each of the samples correlate well with the three tactile sensation indicators including the tactile feeling, the slidability, and the dryness. That is, as the average value μₐᵥₑ decreases, a surface with a better tactile feeling, improved slidability, and adequate dryness may be obtained.

Note that in FIGS. 10 to 12, straight lines (L4 to L6) respectively approximating the correlations between the average value μₐᵥₑ and the evaluation scores for the three tactile sensation indicators are shown for the purpose of reference.

Here, the range from 3.3 points to 3.7 points is assumed to be a threshold for determining whether the tactile feeling of each of Sample A to Sample F is acceptable. In this case, based on the straight line L4 of FIG. 10 representing the correlation between the evaluation score for the tactile feeling and the average value μₐᵥₑ, an acceptable score for the tactile feeling may be obtained when the average value μₐᵥₑ is approximately within a range of μₐᵥₑ<1.4.

Similarly, the range from 3.3 points to 3.7 points is assumed to be a threshold for determining whether the slidability of each of Sample A to Sample F is acceptable. In this case, based on the straight line L5 of FIG. 11 representing the correlation between the evaluation score for the slidability and the average value μₐᵥₑ, an acceptable score for the slidability may be obtained when the average value μₐᵥₑ is approximately within the range of μₐᵥₑ<1.4.

Further, the range from 3.3 points to 3.7 points is assumed to be a threshold for determining whether the dryness of each of Sample A to Sample F is acceptable. In this case, based on the straight line L6 of FIG. 12 representing the correlation between the evaluation score for the dryness and the average value μₐᵥₑ an acceptable score for the dryness may be obtained when the average value μₐᵥₑ is approximately within the range of μₐᵥₑ<1.4.

Based on the above, it can be appreciated that when the average value μₐᵥₑ satisfies the condition μₐᵥₑ<1.4, scores exceeding the acceptability thresholds for the tactile sensation indicators including the tactile feeling, the slidability, and the dryness may be obtained. Thus, by selecting a substrate having a first surface that satisfies the condition μₐᵥₑ<1.4, a substrate having an “operational feel” that is acceptable to many users may be obtained.

Note that with respect to the above determination indicator (μₐᵥₑ<1.4), of the six different samples, Sample F fails to satisfy the condition μₐᵥₑ<1.4 and also fails to meet the acceptability thresholds for any of the tactile feeling, the slidability, and the dryness.

Although Sample E (AFP process only) satisfies the condition μₐᵥₑ<1.4, its evaluation score for the dryness falls slightly below the acceptability threshold value. However, the evaluation scores for the other two of the three tactile sensation indicators are above the acceptability thresholds. Note that the failure of Sample E to meet the acceptability threshold for the dryness may be attributed to the fact that an etching process is not performed on Sample E such that a concavo-convex structure is not formed on the surface of Sample E.

As can be appreciated from the above, the three user-subjective tactile sensation indicators with respect to an operation feel of a substrate may be quantitatively evaluated using the standard deviation σ and the average value μₐᵥₑ of the kinetic friction coefficients μ₁ to μ₁₅ of the substrate surface. In other words, the standard deviation σ and/or the average value μₐᵥₑ of the kinetic friction coefficients μ₁ to μ₁₅ may be used as a determination indicator for evaluating the “operational feel” of the substrate, and by using the determination indicator, a substrate having an “operational feel” that is acceptable to a greater number of users may be selected and provided.

Note that there were no significant differences in the evaluation results between the case where the standard deviation σ was used as the determination indicator and the case where the average value μₐᵥₑ was used as the determination indicator. Thus, in evaluating an “operational feel” of a substrate in practice, at least one of the standard deviation σ and the average value μₐᵥₑ may be used as the determination indicator.

### INDUSTRIAL APPLICABILITY

The present invention may be used to perform property evaluation of a substrate that is applied to a protective cover or the like of a variety of display devices including an LCD device, an OLED device, a tablet display device, and the like.

Further, the present invention is not limited to the embodiments and application examples described above, and various variations and modifications may be made without departing from the scope of the present invention.

The present application is based on Japanese Patent Application No. 2014-177648 filed on Sep. 2, 2014, the entire contents of which are hereby incorporated by reference.

What is claimed is:

1. A method of evaluating an operational feel of a substrate, the method comprising:
(i) a step of preparing a substrate having a first surface;
(ii) a step of measuring a plurality of kinetic friction coefficients μ (μ₁, . . . , μ_{N}, where N is an integer greater than or equal to 2) of the first surface of the substrate, using a tactile contact, under different combinations of a friction speed and a load selected from at least one friction speed within a range from 1 mm/sec to 100 mm/sec and at least two loads within a range from 0.098 N to 1.960 N;
(iii) a step of obtaining a standard deviation σ and an average value μₐᵥₑ of the plurality of kinetic friction coefficients μ that have been measured; and
(iv) a step of determining at least one of whether the standard deviation o satisfies σ<0.5 and whether the average value μₐᵥₑ satisfies μₐᵥₑ<1.4.

2. The method according to claim 1, wherein step (i) includes a step of performing an anti-glare process on the first surface.

3. The method according to claim 1, wherein the substrate includes a transparent substrate made of glass.

4. The method according to claim 3, wherein the glass includes at least one of soda-lime glass and aluminosilicate glass.

5. The method according to claim 3, wherein a chemical strengthening process is performed on the transparent substrate.

6. The method according to claim 1, wherein step (i) includes a step of forming an anti-fingerprint layer on the first surface.

7. The method according to claim 1, wherein
at least six kinetic friction coefficients μ are measured in step (ii) under different combinations of the friction speed and the load selected from at least two different friction speeds within a range from 1 mm/sec to 100 mm/sec and at least three different loads within a range from 0.098 N to 1.960 N.

8. The method according to claim 1, wherein
at least fifteen kinetic friction coefficients μ are measured in step (ii) under different combinations of the friction speed and the load selected from at least three different friction speeds within a range from 1 mm/sec to 100 mm/sec and at least five different loads within a range from 0.098 N to 1.960 N.

9. A substrate including a first surface, the substrate being characterized in that:
when a total of fifteen kinetic friction coefficients μ₁ to μ₁₅ of the first surface of the substrate is measured, using a tactile contact, under different combinations of a friction speed and a load selected from three different friction speeds including 1 mm/sec, 10 mm/sec, and 100 mm/sec, and five different loads including 0.098 N, 0.196 N, 0.490 N, 0.980 N, and 1.960 N,
a standard deviation σ of the kinetic friction coefficients μ₁ to μ₁₅ that have been measured is less than or equal to 0.5; and
an average value μₐᵥₑ of the kinetic friction coefficients μ₁ to μ₁₅ that have been measured is less than or equal to 1.4.

10. The substrate according to claim 9, wherein the first surface includes an anti-fingerprint layer.

11. The substrate according to claim 9, wherein
an arithmetical mean deviation of the roughness profile (Ra) of the first surface is within a range from 10 nm to 700 nm; and/or
a mean width of the roughness profile elements (RSm) of the first surface is within a range from 10 μm to 300 μm.

12. The substrate according to claim 9, wherein the substrate includes a transparent substrate made of glass.

13. The substrate according to claim 12, wherein the glass includes at least one of soda-lime glass and aluminosilicate glass.

14. The substrate according to claim 12, wherein a chemical strengthening process is performed on the transparent substrate.

15. The substrate according to claim 9, characterized by being applied to a protective cover of a touch panel.
